(19) United States
(12) Patent Application Publication
(10) Pub. No.: US 2018/0247201 A1
(43) Pub. Date: Aug. 30, 2018

(54) SYSTEMS AND METHODS FOR IMAGE-TO-IMAGE TRANSLATION USING VARIATIONAL AUTOENCODERS

(71) Applicant: NVIDIA Corporation, Santa Clara, CA (US)

(72) Inventors: Ming-Yu Liu, Sunnyvale, CA (US); Thomas Michael Breuel, Sunnyvale, CA (US); Jan Kautz, Lexington, MA (US)

(21) Appl. No.: 15/907,098

(22) Filed: Feb. 27, 2018

Related U.S. Application Data
(60) Provisional application No. 62/465,083, filed on Feb. 28, 2017.

(51) Int. Cl. G06N 3/08; G06N 3/04; G06T 3/40

(52) U.S. Cl. CPC G06N 3/088; G06T 3/4046; G06N 3/0454

(57) ABSTRACT

A method, computer readable medium, and system are disclosed for training a neural network. The method includes the steps of encoding, by a first neural network, a first image represented in a first domain to convert the first image to a shared latent space, producing a first latent code and encoding, by a second neural network, a second image represented in a second domain to convert the second image to a shared latent space, producing a second latent code. The method also includes the step of generating, by a third neural network, a first translated image in the second domain based on the first latent code, wherein the first translated image is correlated with the first image and weight values of the third neural network are computed based on the first latent code and the second latent code.

### CLAIM OF PRIORITY

This application claims the benefit of U.S. Provisional Application No. 62/465,083 (Attorney Docket No. NVIDP1155+/17-SC-0027-US01) titled “UNSUPERVISED IMAGE-TO-IMAGE TRANSLATION NETWORKS,” filed Feb. 28, 2017, the entire contents of which is incorporated herein by reference.

### FIELD OF THE INVENTION

The present invention relates to training neural networks, and more particularly to training neural networks for image-to-image translation.

### BACKGROUND

A neural network model may be trained to learn an image translation function to translate image from a first domain to a second domain. For example, an image translation function translates an image in one season to a corresponding image in a different season. Similarly, an image translation function may be used to translate images between different weather, time-of day (e.g., day to night), pixel resolution, focus, and dynamic range domains.

Traditionally, supervised training is used to train the neural network model. The supervised training requires a training dataset with image pairs that include an image in the first domain that is perfectly correlated with an image in the second domain. For example, a first image of a traffic intersection in the daytime is paired with a second image of the same traffic intersection in the nighttime. The orientation of the scene, vehicles, and other objects should be the same and in the same positions in both the first and second images (i.e., the images are correlated). In some scenarios, however, obtaining training images is difficult or slow. There is a need for addressing these issues and/or other issues associated with the prior art.

### SUMMARY

A method, computer readable medium, and system are disclosed for training neural networks. The method includes the steps of encoding, by a first neural network, a first image represented in a first domain to convert the first image to a shared latent space, producing a first latent code and encoding, by a second neural network, a second image represented in a second domain to convert the second image to a shared latent space, producing a second latent code. The method also includes the step of generating, by a third neural network, a first translated image in the second domain based on the first latent code, wherein the first translated image is correlated with the first image and weight values of the third neural network are computed based on the first latent code and the second latent code.

### BRIEF DESCRIPTION OF THE DRAWINGS

FIG. 1A is a conceptual illustration of a shared latent space for image-to-image translation technique, in accordance with one embodiment;

FIG. 1B illustrates correlated image pairs for supervised image-to-image translation training and uncorrelated images for unsupervised image-to-image translation training, in accordance with one embodiment;

FIG. 1C illustrates a flowchart of a method for performing image-to-image translation, in accordance with one embodiment;

FIG. 1D illustrates an input image and a translated image generated by an image-to-image translation system, in accordance with one embodiment;

FIG. 1E illustrates a block diagram of an image-to-image translation system, in accordance with one embodiment;

FIG. 2A illustrates another block diagram of an image-to-image translation system, in accordance with one embodiment;

FIG. 2B illustrates a flowchart of a method for performing image-to-image translation using the image-to-image translation system, in accordance with one embodiment;

FIG. 2C illustrates another block diagram of an image-to-image translation system, in accordance with one embodiment;

FIG. 2D illustrates a flowchart of a method for unsupervised training of an image-to-image translation system, in accordance with one embodiment;

FIG. 3 illustrates a parallel processing unit, in accordance with one embodiment;

FIG. 4A illustrates a general processing cluster of the parallel processing unit of FIG. 3, in accordance with one embodiment;

FIG. 4B illustrates a partition unit of the parallel processing unit of FIG. 3, in accordance with one embodiment;

FIG. 5 illustrates the streaming multi-processor of FIG. 4A, in accordance with one embodiment; and

FIG. 6 illustrates an exemplary system in which the various architecture and/or functionality of the various previous embodiments may be implemented.

### DETAILED DESCRIPTION

A technique is described that does not require correlated image pairs to train a neural network to perform image-to-image translation. In other words, an unsupervised neural network model performs image-to-image translation by learning the translation function without requiring corresponding images in two domains. For example, to translate an image of a daytime scene of a traffic intersection to an image of the same scene at nighttime the neural network may be trained with a set of daytime images of the scene and nighttime images. In contrast with supervised training, objects in the scenes are not necessarily correlated. In other words, the orientation of the scene, vehicles, and other objects need not be the same and in the same positions in pairs of the daytime and nighttime images.

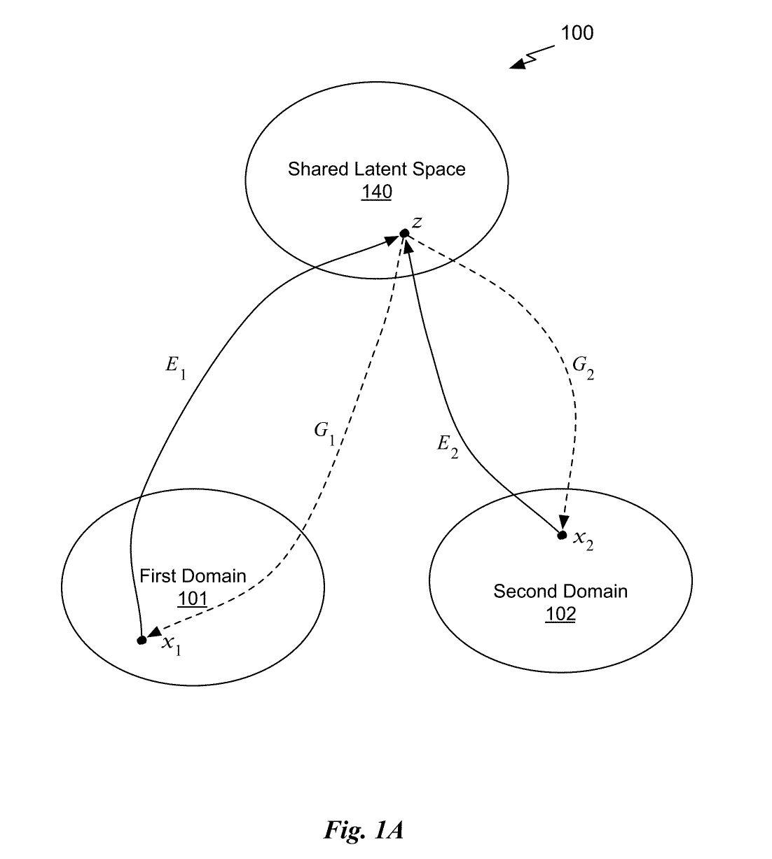

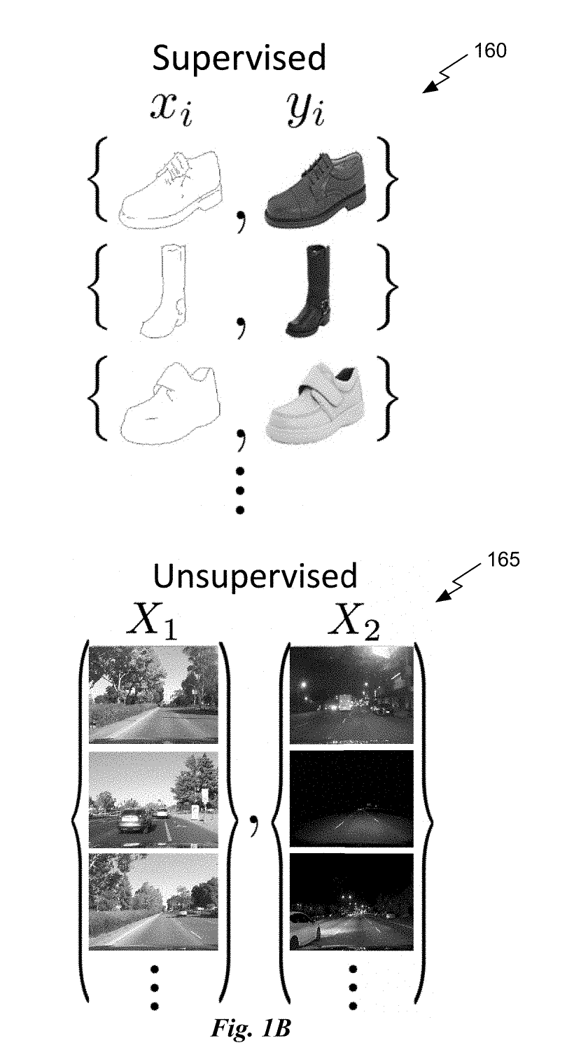

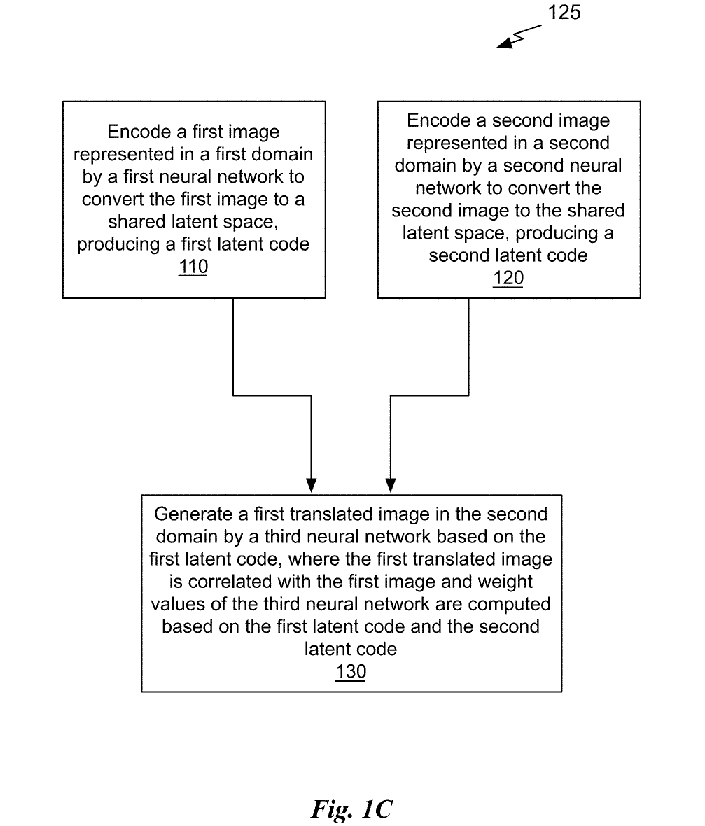

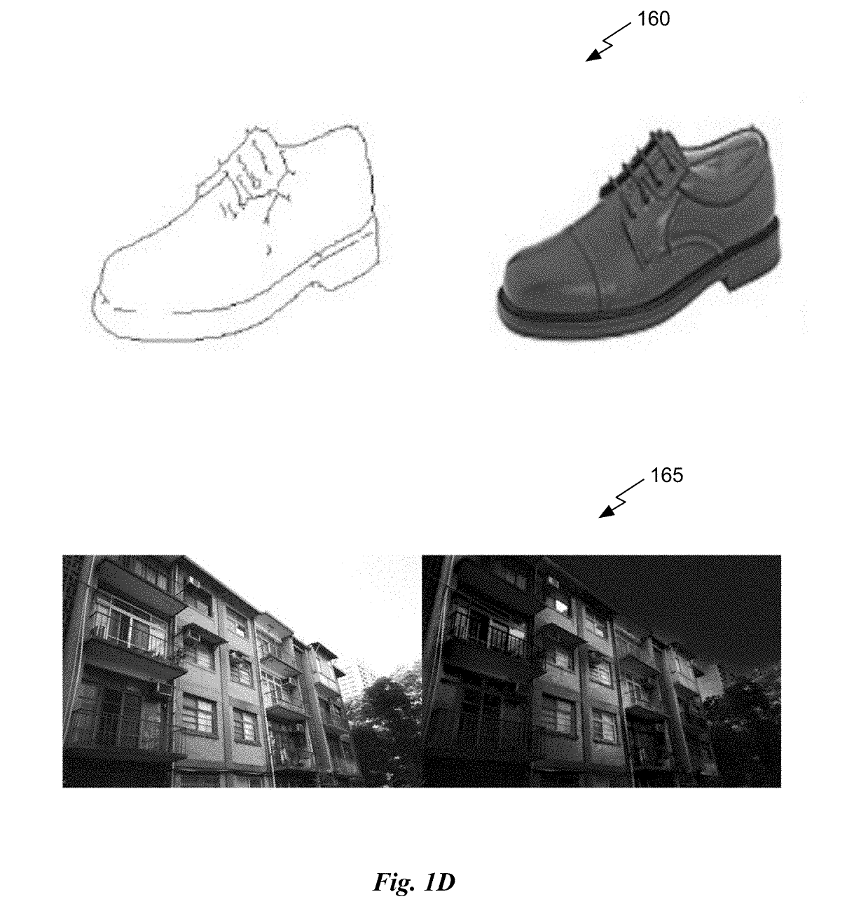

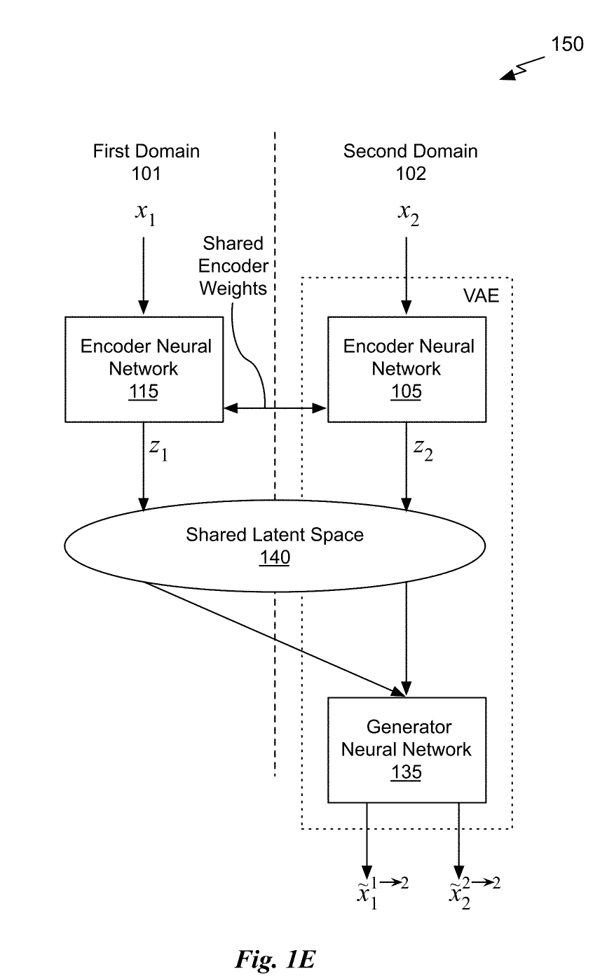

FIG. 1A is a conceptual illustration 100 of a shared latent space 140 for image-to-image translation technique, in accordance with one embodiment. Considering the image translation problem from a probabilistic modeling perspective, the key challenge is to learn a joint distribution of images in different domains. During unsupervised training, an image-to-image translation system learns a joint distribution of images in two different domains by using images from the marginal distributions in each of the two domains.

The task is to infer the joint distribution using images in the two different domains. In general, the coupling theory states there exists an infinite set of joint distributions that can arrive at the given marginal distributions. Hence, inferring the joint distribution from the marginal distributions is a highly ill-posed problem. To address the ill-posed problem, additional assumptions are made regarding the structure of the joint distribution.

Specifically, the image-to-image translation technique is based on an assumption that a pair of corresponding images (x₁, x₂) in two different domains can be mapped to a same latent code z in the shared-latent space 140 (Z). X₁ is a first domain 101 and X₂ is a second domain 102. E₁ and E₂ are two encoding functions, mapping images to latent codes in the shared-latent space 140. G₁ and G₂ are two generation functions, mapping the latent codes to domain-translated images in the two different domains, the first domain 101 and the second domain 102.

FIG. 1B illustrates correlated image pairs 160 for supervised image-to-image translation training and uncorrelated images 165 for unsupervised image-to-image translation training, in accordance with one embodiment. For supervised training, paired of correlated images (x₁, x₂) drawn from a joint distribution P_{X}_{₁}_{,X}_{₂} (x₁, x₂) of the domains X₁ and X₂ are available.

For unsupervised training, only have two independent sets of images are available, where a first set includes images in the first domain 101 and a second set includes images in the second domain 102. Importantly, no paired examples showing how an image could be translated to a correlated image in different domain are used. The samples are drawn from the marginal distributions P_{X}_{₁}(x₁) and P_{X}_{₂}(x₂). Because an infinite set of possible joint distributions can yield the given marginal distributions, nothing can be inferred about the joint distributions from the marginal samples the shared latent space assumption is made. Due to lack of correlated images, the unsupervised training of an image-to-image translation system is considered more difficult, but collection of training data collection is much easier.

FIG. 1C illustrates a flowchart of a method 125 for unsupervised training of an image-to-image translation system, in accordance with one embodiment. The method 125 is described in the context of a neural network, and the method 125 may also be performed by a program, custom circuitry, or by a combination of custom circuitry and a program. For example, the method 125 may be executed by a graphics processing unit (GPU), central processing unit (CPU), or any processor capable of performing the necessary processing operations. Furthermore, persons of ordinary skill in the art will understand that any system that performs method 125 is within the scope and spirit of embodiments of the present invention.

At step 110, a first neural network encodes a first image x₁ represented in the first domain 101 to convert the first image to the shared latent space 140, producing a first latent code z₁. At step 120, a second neural network encodes a second image x₂ represented in the second domain 102 to convert the second image to the shared latent space 140, producing a second latent code z₂. The steps 110 and 120 may be performed in parallel or in sequence starting with either step 110 or step 120. In one embodiment, the first domain 101 is daytime and the second domain 102 is nighttime. In one embodiment, the first domain 101 is synthetic and the second domain 102 is real. In one embodiment, weight values are shared between a last layer of the first neural network and a last layer of the second neural network. More specifically, in one embodiment, the weight values of one or more of the last layers of the first and second neural networks are equal.

The shared-latent space assumption is that for any given pair of images x₁ and x₂, there exists a shared latent code z in the shared latent space 140, such that both of the images can be recovered from the code and the code can be computed from each of the two images. In other words, functions E₁*, E₂*, G₁*, and G₂* exist, such that, given a pair of corresponding images (x₁, x₂) from the joint distribution, z=E₁*(x₁)=E₂*(x₂) and conversely x₁=G₁*(z) and x₂=G₂*(z). In one embodiment, the first and second neural networks implement the functions E₁* and E₂*, respectively.

Within the model, the function x₂=F_{1→2}*(x₁) that maps from X₁ to X₂ can be represented by the composition F_{1→2}*(x₁)=G₂*(E₁*(x₁)). Similarly, x₁=F_{2→1}*(x₂)=G₁*(E₂*(2)). The problem then becomes a problem of learning F_{1→2}* and F_{2→1}*. Note that a necessary condition for F_{1→2}* and F_{2→1}* to exist is the cycle-consistency constraint: x₁=F_{2→1}*(F_{1→2}*(x₁)) and x₂=F_{1→2}*(F_{2→1}*(x₂)). The input image can be reconstructed by translating back the translated input image. In other words, the proposed shared-latent space assumption implies the cycle-consistency assumption (but not vice versa).

At step 130, a third neural network generates a first translated image in the second domain 102 based on the first latent code, where the first translated image is correlated with the first image and weight values of the third neural network are computed based on the first latent code and the second latent code. In one embodiment, the third neural network implements the function G₂*. In one embodiment, the first latent code and the second latent code are equal (z₁=z₂). In one embodiment, a combination of the first and third neural networks form a variational autoencoder (VAE).

The first and third neural networks are deemed to be sufficiently trained when the first translated image is correlated with the first image or a threshold accuracy is achieved. Earlier during the training, the first translated image may be partially correlated with the first image. Parameters (i.e., weights) of the first neural network, the second neural network, and the third neural network are adjusted during training to improve accuracy of the image-to-image translation system.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 1D illustrates input images and translated images generated by the image-to-image translation system, in accordance with one embodiment. In one embodiment, the image-to-image translation system is trained to translate sketch or hand drawn images into real images as shown by the image pair 160. In another embodiment, the image-to-image translation system is trained to translate daytime images into nighttime images, as shown by the image pair 165.

FIG. 1E illustrates a block diagram of an image-to-image translation system 150, in accordance with one embodiment. In one embodiment, E₁, E₂, and G₂ from FIG. 1A are implemented as encoder neural network 115, encoder neural network 105, and generator neural network 135, respectively. The encoder neural network 115 receives an input image (x₁) in the first domain 101 (X₁) and generates the first latent code (z₁) in the shared latent space 140. The encoder neural network 105 receives an input image (x₂) in the second domain 102 (X₂) and generates the second latent code (z₂) in the shared latent space 140.

In one embodiment, the encoder neural network 115, the encoder neural network 105, and the generator neural network 135, are each a convolutional neural network (CNN) and the shared-latent space assumption is implemented using a weight sharing constraint, where the connection weights of one or more of the last layers in the encoder neural network 115 and the encoder neural network 105 are shared. The connection weights of one or more of the last layers in the encoder neural network 115 and the encoder neural network 105 (i.e., encoder weights) are responsible for extracting high-level representations of the input images in the two domains. The combination of the encoder neural network 105 and the generator neural network 135 forms a first VAE.

The generator neural network 135 in the second domain 102 receives the first latent code and the second latent code (z₁ and z₂) and generates a first translated image in the second domain 102 that is correlated with the first input image. The first translated image in the second domain 102 is a domain translated image \tilde{x}₁^{1→2}. The generator neural network 135 in the second domain 102 also generates a first reconstructed image in the second domain 102 that is correlated with the second input image (x₂). The first reconstructed image in the second domain 102 is a self-reconstructed image \tilde{x}₂^{2→2}.

In one embodiment, during training, the domain-translated image \tilde{x}₁^{1→2}, the self-reconstructed image \tilde{x}₂^{2→2}, and the input image (x₂) in the second domain 102 (X₂) are input to an adversarial discriminator for the second domain 102. The adversarial discriminator evaluates whether the domain-translated images are realistic and provides updated layer parameters (e.g., weights) for the encoder neural network 115, the encoder neural network 105, and the generator neural network 135 based on the evaluation. In one embodiment, the first latent code and the second latent code (z₁ and z₂) are used to compute the updated layer parameters, including the shared encoder weights.

The VAE for the second domain 102 maps x₂ to a code in the shared latent space 140 via the encoder neural network 105 and then decodes a random-perturbed version of the code to reconstruct the input image via the generator neural network 135. The components in the shared-latent space 140 are assumed to be conditionally independent and Gaussian with unit variance. The encoder neural network 115 (E₁) outputs a mean vector E_{μ,1} (x₁) and the distribution of the latent code z₁ is given by q₁(z₁|x₁)≡N(z₁|E_{μ,1}(x₁),l), where l is an identity matrix. The encoder neural network 105 (E₂) outputs a mean vector E_{μ,2}(x₂) and the distribution of the latent code z₂ is given by q₂(z₂|x₂)≡N(z₂|E_{μ,2}(x₂),l). The output latent codes z₁ and z₂ are then sampled and input to the generator neural network 135 to generate the domain translated image \tilde{x}₁^{1→2}=G₂(z₁˜q₁(z₁|x₁)) and the reconstructed image \tilde{x}₂^{2→2}=G₂(z₂˜q₂(z₂|x₂)). Note that the notation is relaxed since the distribution of q₂(z₂|x₂) is treated as a random vector of N(z₂|E_{μ,2}(x₂),l) and sampled from it.

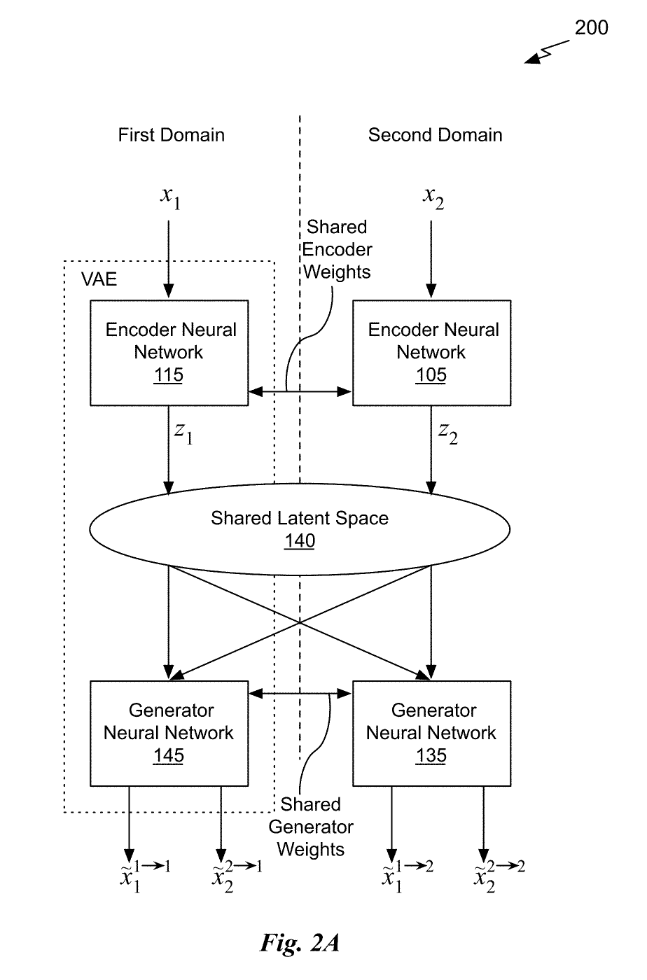

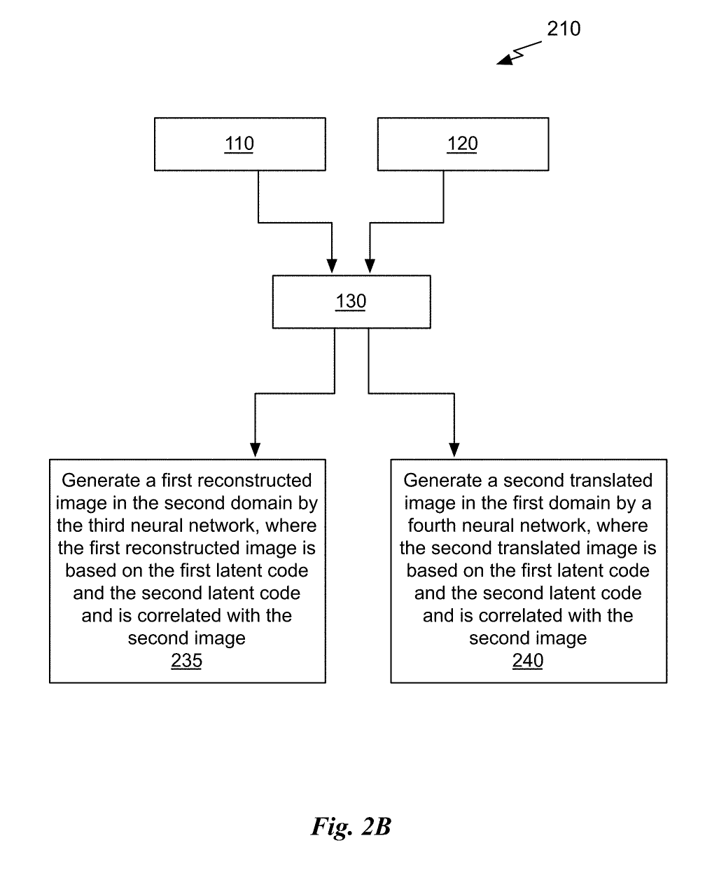

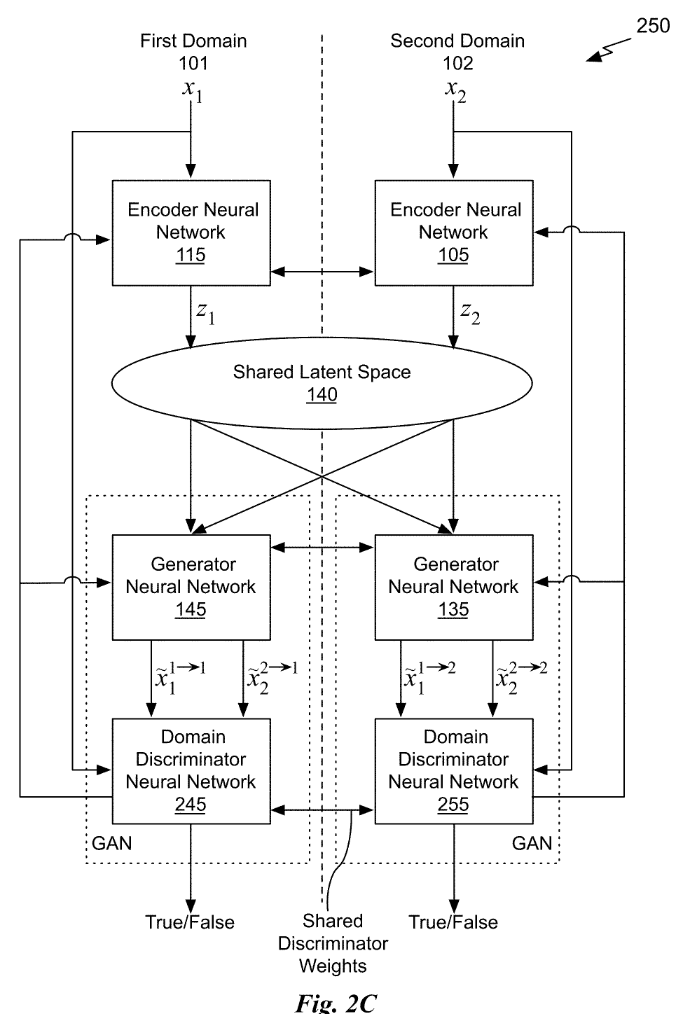

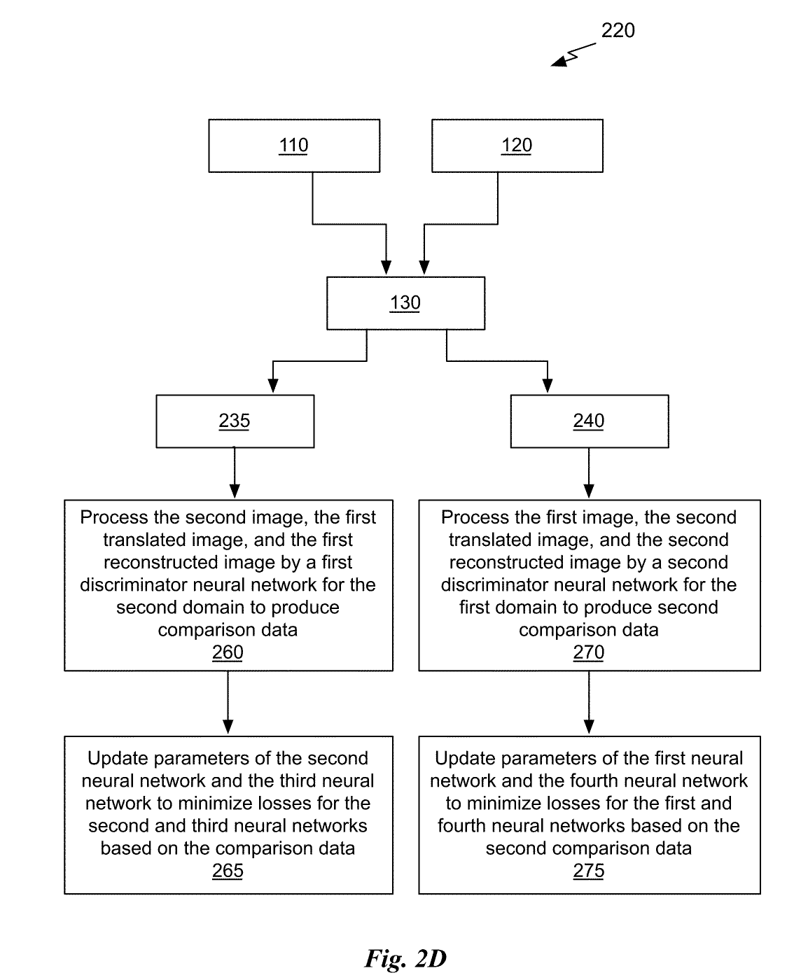

FIG. 2A illustrates another block diagram of an image-to-image translation system 200, in accordance with one embodiment. In addition to the encoder neural network 115, the encoder neural network 105, and the generator neural network 135, shown in FIG. 1E, a second generator neural network 145 is included in the first domain 101 (X₁).

In one embodiment, G₁ from FIG. 1A is implemented as the generator neural network 145. In one embodiment, the generator neural network 135 and the generator neural network 145, are each a CNN and the shared-latent space assumption is implemented using a weight sharing constraint, where the connection weights of one or more of the first layers in the generator neural network 135 and the generator neural network 145 (i.e., generator weights) are shared. The first layers in the generator neural network 135 and the generator neural network 145 are responsible for decoding high-level representations for reconstructing the input images. The combination of the encoder neural network 115 and the generator neural network 135 forms a second VAE.

The generator neural network 145 in the first domain 101 receives the first latent code and the second latent code (z₁ and z₂) and generates a second translated image in the first domain 101 that is correlated with the second input image. The second translated image in the first domain 101 is a domain translated image \tilde{x}₂^{2→1}. The generator neural network 145 in the first domain 101 also generates a second reconstructed image in the first domain 101 that is correlated with the first input image (x₁). The second reconstructed image in the first domain 101 is a self-reconstructed image \tilde{x}₁^{1→1}.

In one embodiment, during training, the domain-translated image \tilde{x}₂^{2→1}, the self-reconstructed image \tilde{x}₁^{1→1}, and the input image (x₁) in the first domain 101 (X₁) are input to an adversarial discriminator (note shown) for the first domain 101. The adversarial discriminator evaluates whether the domain-translated images are realistic and provides updated layer parameters (e.g., weights) for the encoder neural network 115, the encoder neural network 105, the generator neural network 135, and the generator neural network 145 based on the evaluation. The updated parameters include a portion of weights that are shared between the first domain 101 and the second domain 102. Specifically, a portion of the weights that are shared includes the shared encoder weights and the shared generator weights. In one embodiment, the VAEs are trained using backpropagation. To implement backpropagation, the sampling of the first latent code and the second latent code (z₁ and z₂) is reparameterized as a differentiable operation using auxiliary random variables, where η is a random vector with a multi-variate Gaussian distribution: η˜N(η|0,l). The sampling operations of z₁˜q₁(z₁|x₁) and z₂˜q₂(z₂|x₂) can be implemented via z₁=E_{μ,1}(x₁)+η and z₂=E_{μ,2}(x₂)+η, respectively.

To implement the shared-latent space assumption, a shared intermediate representation h is assumed such that the process of generating a pair of correlated images admits a form of

$$z -> h \{ \begin{matrix}{x}_{1} \\ {x}_{2}\end{matrix} .$$

Consequently, G₁*≡G_{L,1}*∘G_{H}* and G₂*≡G_{L,2}*∘G_{H}* where G_{H}* is a common high-level generation function that maps z to h and G_{L,1}* and G_{L,2}* are low-level generation functions that map h to x₁ and x₂, respectively. In the case of multi-domain image translation (e.g., sunny and rainy image translation), z can be regarded as the compact, high-level representation of a scene (“car in front, trees in back”), and h can be considered a particular realization of z through G_{H}* (“car/tree occupy the following pixels”), and G_{L,1}* and G_{L,2}* would be the actual image formation functions in each modality (“tree is lush green in the sunny domain, but dark green in the rainy domain”). Assuming h also allows the representation of E₁* and E₂* by E₁*≡E_{H}*∘E_{L,1}* and E₂*≡E_{H}*∘E_{L,2}*.

The second VAE for the first domain 101 maps x₁ to a code in the shared latent space 140 via the encoder neural network 115 and then decodes a random-perturbed version of the code to reconstruct the input image via the generator neural network 145. The output latent codes z₁ and z₂ are sampled and input to the generator neural network 145 to generate the domain translated image \tilde{x}₂^{2→1}=G₁(z₂˜q₂(z₂|x₂)) and the reconstructed image \tilde{x}₁^{1→1}=G₁(z₁˜q₁(z₁|x₁)).

Note that the weight-sharing constraint alone does not guarantee that corresponding images in two domains will have the equal latent codes. In the unsupervised setting, no pair of corresponding images in the two domains exists to train the network to output equal latent codes. The extracted latent codes for a pair of corresponding images are different in general. Even if they are the equal, the same latent component may have different semantic meanings in different domains. Hence, the same latent code could still be decoded to output two unrelated images. However, through adversarial training, a pair of corresponding images in the two domains can be mapped to a common latent code by E₁ and E₂, respectively, and a latent code will be mapped to a pair of corresponding images in the two domains by G₁ and G₂, respectively.

FIG. 2B illustrates a flowchart of another method 210 for image-to-image translation, in accordance with one embodiment. The method 210 is described in the context of a neural network, and the method 210 may also be performed by a program, custom circuitry, or by a combination of custom circuitry and a program. For example, the method 210 may be executed by a graphics processing unit (GPU), central processing unit (CPU), or any processor capable of performing the necessary processing operations. In one embodiment, the method 210 is performed by the image-to-image translation system 200. Furthermore, persons of ordinary skill in the art will understand that any system that performs method 210 is within the scope and spirit of embodiments of the present invention.

Steps 110, 120, and 130 are completed as previously described in conjunction with FIG. 1C. At step 235, the generator neural network 135 generates a first reconstructed image in the second domain 102, where the first reconstructed image \tilde{x}₂^{2→2} is based on the first latent code and the second latent code and is correlated with the second image x₂. At step 240, the generator neural network 145 generates a second translated image in the first domain 101, where the second translated image \tilde{x}₂^{2→1} is based on the first latent code and the second latent code and is correlated with the second image x₂.

The image-to-image translation system 200 provides two image translation streams, X₁→X₂ to translate an image x₁ in X₁ to an image x₂ in X₂ and X₂→X₁ to translate an image x₂ in X₂ to an image x₁ in X₁. The image-to-image translation system 200 provides two image reconstruction streams. The two image translation streams are trained jointly with the two image reconstruction streams from the VAEs. When it can be ensured that a pair of corresponding images are mapped to a same latent code and a same latent code is decoded to a pair of corresponding images, (x₁,G₂(z₁˜q₁(z₁|x₁))) would form a pair of corresponding images. In other words, the composition of E₁ and G₂ approximates F_{1→2}* for unsupervised image-to-image translation, and the composition of E₂ and G₁ approximates F_{2→1}*.

FIG. 2C illustrates another block diagram of an image-to-image translation system 250, in accordance with one embodiment. In addition to the encoder neural network 115, the encoder neural network 105, the generator neural network 135, and the generator neural network 145 shown in FIG. 2A, a domain discriminator neural network 245 is included in the first domain 101 (X₁) and a domain discriminator neural network 255 is included in the second domain 102 (X₂). In one embodiment, the domain discriminator neural network 245 is an adversarial discriminator D₁ and the domain discriminator neural network 255 is an adversarial discriminator D₂. In one embodiment, the domain-translated image \tilde{x}₂^{2→1}, the self-reconstructed image \tilde{x}₁^{1→1}, and the input image (x₁) in the first domain 101 X₁ are input to the domain discriminator neural network 245. In one embodiment, the domain-translated image \tilde{x}₁^{1→2}, the self-reconstructed image \tilde{x}₂^{2→2}, and the input image (x₂) in the second domain 102 X₂ are input to the domain discriminator neural network 255.

In one embodiment, the combination of the domain discriminator neural network 245 and the generator neural network 145 is a first generative adversarial network (GAN). In one embodiment, the combination of the domain discriminator neural network 255 and the generator neural network 135 is a second GAN. The adversarial training objective interacts with the weight-sharing constraint to enforce the shared-latent space 140 to generate correlated images in two domains, while the VAEs relate translated images with input images in the respective domains. Updated parameters computed by the domain discriminator neural network 245 and the domain discriminator neural network 255 include a portion of weights that are shared between the first domain 101 and the second domain 102. Specifically, a portion of the weights that are shared includes the shared encoder weights, the shared generator weights, and the shared discriminator weights.

In the first GAN, for real images sampled from the first domain 101, the domain discriminator neural network 245 should output true, while for images generated by the generator neural network 145, the domain discriminator neural network 245 should output false. The generator neural network 145 can generate two types of images: images from the reconstruction stream \tilde{x}₁^{1→1}=G₁(z₁˜q₁(z₁|x₁)) and images from the translation stream \tilde{x}₂^{2→1}=G₁(z₂˜q₂(z₂|x₂)). Since the reconstruction stream can be supervisedly trained, adversarial training need only be applied to images from the translation stream, \tilde{x}₂^{2→1}. Similar processing is applied to the second GAN, where the domain discriminator neural network 255 is trained to output true for real images sampled from the second domain dataset and false for images generated from the generator neural network 135.

The learning problems of the first and second VAEs and first and second GANs may be jointly solved for the image reconstruction streams, the image translation streams, and the cycle-reconstruction streams:

$${min}_{{E}_{1} , {E}_{2} , {G}_{1} , {G}_{2}} {max}_{{D}_{1} , {D}_{2}} {ℒ}_{{VAE}_{1}} ( {E}_{1} , {G}_{1} ) + {ℒ}_{{GAN}_{1}} ( {E}_{1} , {G}_{1} , {D}_{1} ) + {ℒ}_{{CC}_{1}} ( {E}_{1} , {G}_{1} , {E}_{2} , {G}_{2} ) \\ {ℒ}_{{VAE}_{2}} ( {E}_{2} , {G}_{2} ) + {ℒ}_{{GAN}_{2}} ( {E}_{2} , {G}_{2} , {D}_{2} ) + {ℒ}_{{CC}_{2}} ( {E}_{2} , {G}_{2} , {E}_{1} , {G}_{1} ) . \qquad ( 1 )$$

VAE training aims for minimizing a variational upper bound in equation (1), the VAE objects are

[symbol]

_{VAE}_{₁}(E₁,G₁)=λ₁KL(q₁(z₁|x₁)∥p_{η}(z))−λ₂ [symbol] _{z}_{₁}_{˜q}_{₁}_{(z}_{₁}_{|x}_{₁}₎[log p_{G}_{₁}(x₁|z₁)]. (2)

[symbol]

_{VAE}_{₂}(E₂,G₂)=λ₂KL(q₂(z₂|x₂)∥p_{η}(z))−λ₂ [symbol] _{z}_{₂}_{˜q}_{₂}_{(z}_{₂}_{|x}_{₂}₎[log p_{G}_{₂}(x₂|z₂)]. (3)

where the hyper-parameters λ₁ and λ₂ control the weights of the objective terms and the KL divergence terms penalize deviation of the distribution of the latent code from the prior distribution. The regularization allows an easy way to sample from the shared latent space 140. p_{G}_{₁} and p_{G}_{₂} are modeled using Laplacian distributions. Hence, minimizing the negative log-likelihood term is equivalent to minimizing the absolute distance between the image and the reconstructed image. The prior distribution is a zero mean Gaussian p_{η}(z)=N(z|0,l).

In equation (1), the GAN objective functions are given by

[symbol]

_{GAN}_{₁}(E₁,G₁,D₁)=λ₀ [symbol] ₓ_{₁}_{˜px}_{₁} log D₁(x₁)+λ₀ [symbol] _{z}_{₂}_{˜q}_{₂}_{(z}_{₂}_{|x}_{₂}₎[log(1−D₁(G₁(z₂)))] (4)

[symbol]

_{GAN}_{₂}(E₂,G₂,D₂)=λ₀ [symbol] ₓ_{₂}_{˜px}_{₂} log D₂(x₂)+λ₀ [symbol] _{z}_{₁}_{˜q}_{₁}_{(z}_{₁}_{|x}_{₁}₎[log(1−D₂(G₂(z₁)))] (5)

The objective functions in equations (4) and (5) are conditional GAN objective functions that are used to ensure the translated images resemble images in the target domains. The hyper-parameter λ₀ controls the impact of the GAN objective functions.

A VAE-like objective function is used to model the cycle-consistency constraint, which is given by

[symbol]

_{CC}_{₁}(E₁,G₁,E₂,G₂)=λ₃KL(q₁(z₁|x₁∥p_{η}(z))+λ₃KL(q₂(z₂|x₁^{1→2})∥p_{η}(z))−λ₄ [symbol] _{z}_{₂}_{˜q}_{₂}_{(z}_{₂}_{|x}_{₁}_{^{1→2}}₎[log p_{G}_{₁}(x₁|z₂)] (6)

[symbol]

_{CC}_{₂}(E₂,G₂,E₁,G₁)=λ₃KL(q₂(z₂|x₂∥p_{η}(z))+λ₃KL(q₁(z₁|x₂^{2→1})∥p_{η}(z))−λ₄ [symbol] _{z}_{₁}_{˜q}_{₁}_{(z}_{₁}_{|x}_{₂}_{^{2→1}}₎[log p_{G}_{₂}(x₂|z₁)] (7)

where the negative log-likelihood objective term ensures a twice translated image resembles the input one and the KL terms penalize the latent codes deviating from the prior distribution in the cycle-reconstruction stream (Therefore, there are two KL terms). The hyper-parameters λ₃ and) λ₄ control the weights of the two different objective terms. The parameters of the image-to-image translation systems 150, 200, and 250 are learned and updated based on one or more of the first latent code z₁, the second latent code z₂, the first image x₁, the second image x₂, the first translated image x₂^{2→1}, the second translated image x₁^{1→2}, the first reconstructed image x₁^{1→1}, and the second reconstructed image x₂^{2→2}. The updated parameters include a portion of weights that are shared between the first domain 101 and the second domain 102. Specifically, a portion of the weights that are shared includes the shared encoder weights, the shared generator weights, and the shared discriminator weights.

Inheriting from GAN, training of the image-to-image translation system 250 results in solving a min-max problem where the optimization aims to find a saddle point. It can be seen as a two player zero-sum game. The first player is a team consisting of the first and second VAEs. The second player is a team consisting of the domain discriminator neural networks 245 and 255 (i.e., adversarial discriminators). In addition to defeating the second player, the first player has to minimize the VAE losses and the cycle-consistency losses. In one embodiment, an alternating gradient update scheme is applied to solve equation (1). Specifically, a gradient ascent step is applied to update D₁ and D₂ with E₁, E₂, G₁, and G₂ fixed. Then a gradient descent step is applied to update E₁, E₂, G₁, and G₂ with D₁ and D₂ fixed.

In one embodiment, during training, the domain discriminator neural network 245 (D₁) updates parameter values for the encoder neural network 115 (E₁) and the generator neural network 145 (G₁). In one embodiment, during training, the domain discriminator neural network 255 (D₂) updates parameter values for the encoder neural network 105 (E₂) and the generator neural network 135 (G₂). After learning, two image translation functions are implemented by the image-to-image translation system 200. The function F_{1→2}*(x₁)=G₂(z₁˜q₁(z₁|x₁)) may be used to translate images from the first domain 101 to the second domain 102 and the function F_{2→1}*(x₂)=G₁(z₂˜q₂(z₂|x₂)) may be used to translate images from the second domain 102 to the first domain 101.

FIG. 2D illustrates a flowchart of a method 220 for unsupervised training of an image-to-image translation system, in accordance with one embodiment. The method 220 is described in the context of a neural network, and the method 220 may also be performed by a program, custom circuitry, or by a combination of custom circuitry and a program. For example, the method 220 may be executed by a graphics processing unit (GPU), central processing unit (CPU), or any processor capable of performing the necessary processing operations. In one embodiment, the method 210 is performed by the image-to-image translation system 250. Furthermore, persons of ordinary skill in the art will understand that any system that performs method 220 is within the scope and spirit of embodiments of the present invention.

Steps 110, 120, and 130 are completed as previously described in conjunction with FIG. 1A and steps 235 and 240 are completed as previously described in conjunction with FIG. 2B. At step 260, the domain discriminator neural network 255 processes the second image (x₂) in the second domain 102 X₂, the first translated image \tilde{x}₁^{1→2}, and the first reconstructed image \tilde{x}₂^{2→2} to produce comparison data. At step 270, the domain discriminator neural network 245 processes the first image (x₁) in the first domain 101 X₁, the second translated image \tilde{x}₂^{2→1}, and the second reconstructed image \tilde{x}₁^{1→1} to produce second comparison data. In one embodiment, the comparison data and the second comparison data includes one or more of [symbol] _{VAE}_{₁}(E₁,G₁), [symbol] _{VAE}_{₂}(E₂,G₂), [symbol] _{GAN}_{₁}(E₁,G₁,D₁), [symbol] _{GAN}_{₂}(E₂,G₂,D₂), [symbol] _{CC}_{₁}(E₁,G₁,E₂,G₂), and [symbol] _{CC}_{₂}(E₂,G₂,E₁,G₁).

At step 265, the domain discriminator neural network 255 updates parameters of the second neural network and the third neural network (i.e., first VAE) to minimize losses of the first VAE based on the comparison data. At step 275, the domain discriminator neural network 255 updates parameter of the first neural network and the fourth neural network (i.e., second VAE) to minimize losses of the second VAE based on the second comparison data. In one embodiment, the parameters are not adjusted for each output, but are instead adjusted for a batch of N outputs, where N is greater than 1. In one embodiment, equation (1) is used to adjust the parameters. The method 220 may be repeated until a desired accuracy is achieved for the first and second VAEs.

The image-to-image translation system 200 may be used to translate between several different domains. In one embodiment, the image-to-image translation system 200 is trained to translate street scene images from sunny to rainy, day to night, summery to snowy, and vice versa. In one embodiment, for each task, a set of images extracted from driving videos recorded at different days and cities. The numbers of the images in the sunny/day, rainy, night, summery, and snowy sets are 86,165, 28,915, 36,280, 6,838, and 6,044 and the image-to-image translation system 200 was trained to translate street scene image of size 640×480 pixels.

In one embodiment, the image-to-image translation system 200 is trained to translate between synthetic and real domains. For the real to synthetic translation, the training method 220 may produce translated cityscape images to cartoon like images. In one embodiment, the image-to-image translation system 200 is trained to translate between different dog breeds (e.g., old English sheep dog, corgi, husky, German shepherd, Samoyed, etc.) In one embodiment, the image-to-image translation system 200 is trained to translate between different cat species (e.g., house cat, tiger, lion, cougar, leopard, jaguar, and cheetah). In one embodiment, the image-to-image translation system 200 is trained to translate face attributes. Examples of face attributes, include hair color, expression, facial hair, and eyeglasses. Images of faces with a first attribute constitute the first domain 101, while images of faces without the first attribute constitute the second domain 102. In one example, input images that do not have blond hair, eye glasses, goatee, and smiling expression may be translated to correlated images with each of the individual attributes.

Importantly, correlated image pairs are not needed to train the encoder neural network 115, the encoder neural network 105, the generator neural network 135, the generator neural network 145, the domain discriminator neural network 245, and the domain discriminator neural network 255 in the image-to-image translation system 250. Instead, images in each domain are used that do not need to be correlated. Therefore, acquisition of training data is greatly simplified. A feature of the image-to-image translation systems 200 and 250 is that translation can be performed in either direction because the systems include 2 VAEs.

### Parallel Processing Architecture

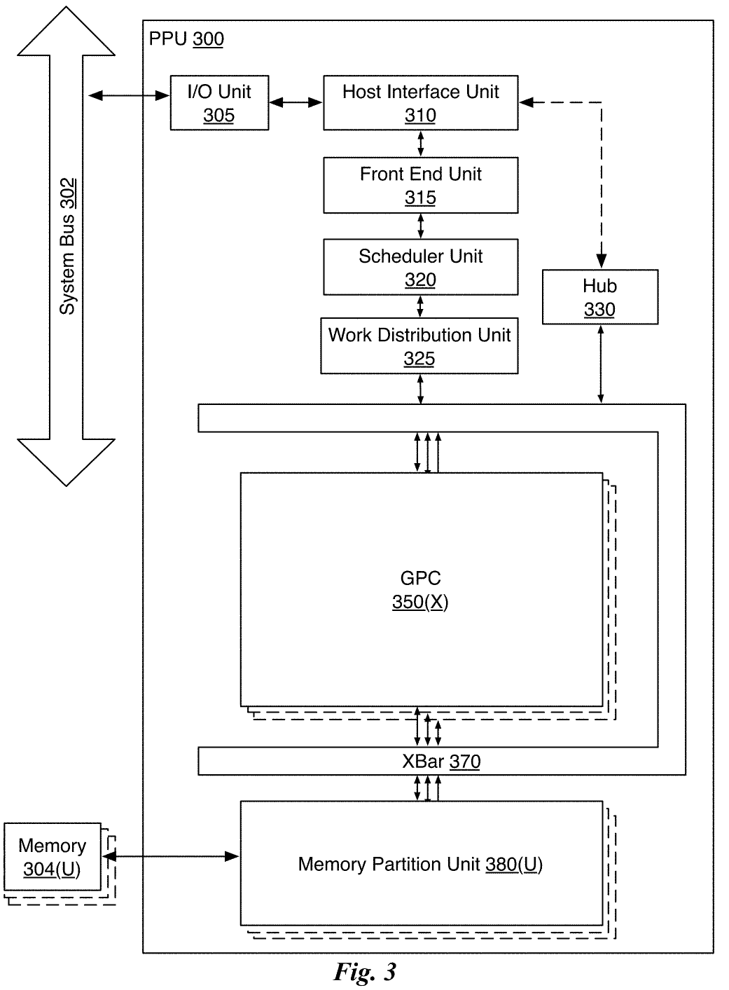

FIG. 3 illustrates a parallel processing unit (PPU) 300, in accordance with one embodiment. The PPU 300 may be configured to implement the image-to-image translation system 150, 200, or 250.

In one embodiment, the PPU 300 is a multi-threaded processor that is implemented on one or more integrated circuit devices. The PPU 300 is a latency hiding architecture designed to process a large number of threads in parallel. A thread (i.e., a thread of execution) is an instantiation of a set of instructions configured to be executed by the PPU 300. In one embodiment, the PPU 300 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 300 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

As shown in FIG. 3, the PPU 300 includes an Input/Output (I/O) unit 305, a host interface unit 310, a front end unit 315, a scheduler unit 320, a work distribution unit 325, a hub 330, a crossbar (Xbar) 370, one or more general processing clusters (GPCs) 350, and one or more partition units 380. The PPU 300 may be connected to a host processor or other peripheral devices via a system bus 302. The PPU 300 may also be connected to a local memory comprising a number of memory devices 304. In one embodiment, the local memory may comprise a number of dynamic random access memory (DRAM) devices.

The I/O unit 305 is configured to transmit and receive communications (i.e., commands, data, etc.) from a host processor (not shown) over the system bus 302. The I/O unit 305 may communicate with the host processor directly via the system bus 302 or through one or more intermediate devices such as a memory bridge. In one embodiment, the I/O unit 305 implements a Peripheral Component Interconnect Express (PCIe) interface for communications over a PCIe bus. In alternative embodiments, the I/O unit 305 may implement other types of well-known interfaces for communicating with external devices.

The I/O unit 305 is coupled to a host interface unit 310 that decodes packets received via the system bus 302. In one embodiment, the packets represent commands configured to cause the PPU 300 to perform various operations. The host interface unit 310 transmits the decoded commands to various other units of the PPU 300 as the commands may specify. For example, some commands may be transmitted to the front end unit 315. Other commands may be transmitted to the hub 330 or other units of the PPU 300 such as one or more copy engines, a video encoder, a video decoder, a power management unit, etc. (not explicitly shown). In other words, the host interface unit 310 is configured to route communications between and among the various logical units of the PPU 300.

In one embodiment, a program executed by the host processor encodes a command stream in a buffer that provides workloads to the PPU 300 for processing. A workload may comprise a number of instructions and data to be processed by those instructions. The buffer is a region in a memory that is accessible (i.e., read/write) by both the host processor and the PPU 300. For example, the host interface unit 310 may be configured to access the buffer in a system memory connected to the system bus 302 via memory requests transmitted over the system bus 302 by the I/O unit 305. In one embodiment, the host processor writes the command stream to the buffer and then transmits a pointer to the start of the command stream to the PPU 300. The host interface unit 310 provides the front end unit 315 with pointers to one or more command streams. The front end unit 315 manages the one or more streams, reading commands from the streams and forwarding commands to the various units of the PPU 300.

The front end unit 315 is coupled to a scheduler unit 320 that configures the various GPCs 350 to process tasks defined by the one or more streams. The scheduler unit 320 is configured to track state information related to the various tasks managed by the scheduler unit 320. The state may indicate which GPC 350 a task is assigned to, whether the task is active or inactive, a priority level associated with the task, and so forth. The scheduler unit 320 manages the execution of a plurality of tasks on the one or more GPCs 350.

The scheduler unit 320 is coupled to a work distribution unit 325 that is configured to dispatch tasks for execution on the GPCs 350. The work distribution unit 325 may track a number of scheduled tasks received from the scheduler unit 320. In one embodiment, the work distribution unit 325 manages a pending task pool and an active task pool for each of the GPCs 350. The pending task pool may comprise a number of slots (e.g., 32 slots) that contain tasks assigned to be processed by a particular GPC 350. The active task pool may comprise a number of slots (e.g., 4 slots) for tasks that are actively being processed by the GPCs 350. As a GPC 350 finishes the execution of a task, that task is evicted from the active task pool for the GPC 350 and one of the other tasks from the pending task pool is selected and scheduled for execution on the GPC 350. If an active task has been idle on the GPC 350, such as while waiting for a data dependency to be resolved, then the active task may be evicted from the GPC 350 and returned to the pending task pool while another task in the pending task pool is selected and scheduled for execution on the GPC 350.

The work distribution unit 325 communicates with the one or more GPCs 350 via XBar 370. The XBar 370 is an interconnect network that couples many of the units of the PPU 300 to other units of the PPU 300. For example, the XBar 370 may be configured to couple the work distribution unit 325 to a particular GPC 350. Although not shown explicitly, one or more other units of the PPU 300 are coupled to the host interface unit 310. The other units may also be connected to the XBar 370 via a hub 330.

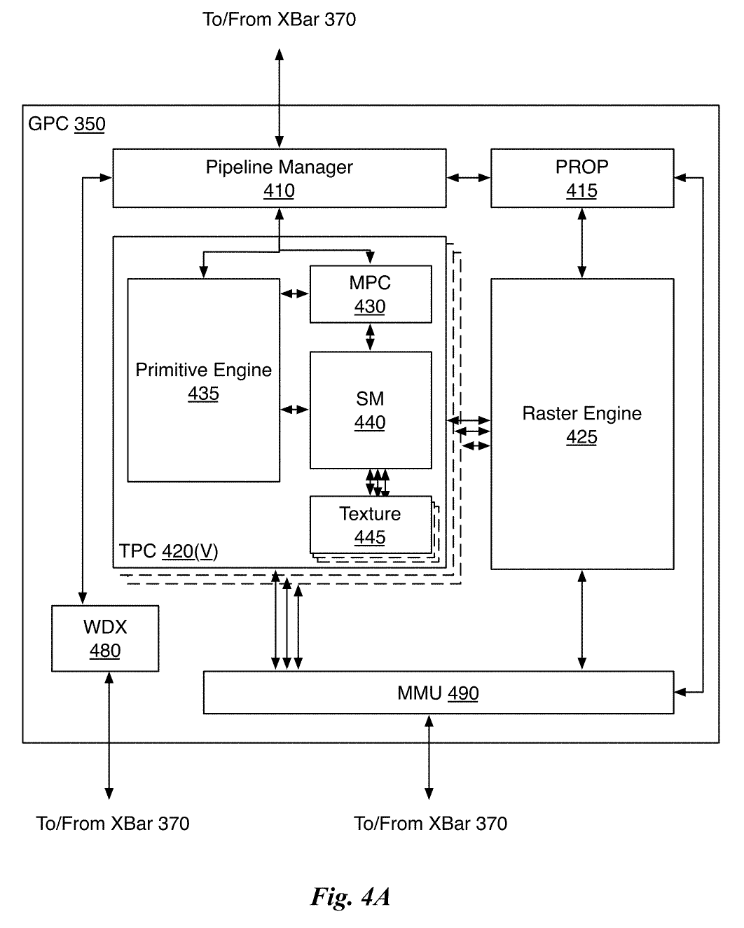

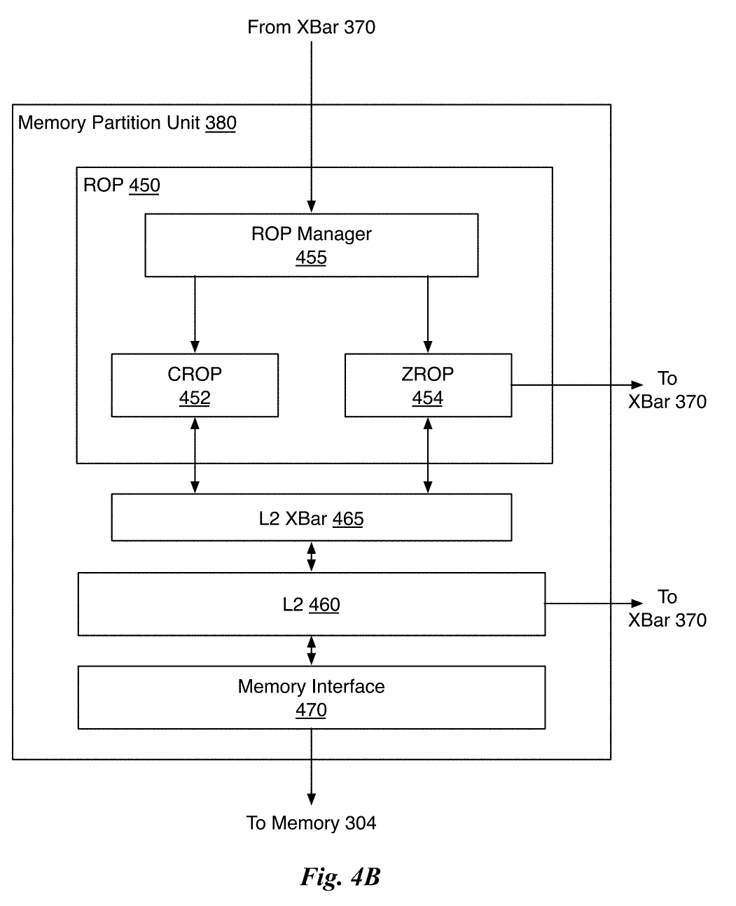

The tasks are managed by the scheduler unit 320 and dispatched to a GPC 350 by the work distribution unit 325. The GPC 350 is configured to process the task and generate results. The results may be consumed by other tasks within the GPC 350, routed to a different GPC 350 via the XBar 370, or stored in the memory 304. The results can be written to the memory 304 via the partition units 380, which implement a memory interface for reading and writing data to/from the memory 304. In one embodiment, the PPU 300 includes a number U of partition units 380 that is equal to the number of separate and distinct memory devices 304 coupled to the PPU 300. A partition unit 380 will be described in more detail below in conjunction with FIG. 4B.

In one embodiment, a host processor executes a driver kernel that implements an application programming interface (API) that enables one or more applications executing on the host processor to schedule operations for execution on the PPU 300. An application may generate instructions (i.e., API calls) that cause the driver kernel to generate one or more tasks for execution by the PPU 300. The driver kernel outputs tasks to one or more streams being processed by the PPU 300. Each task may comprise one or more groups of related threads, referred to herein as a warp. A thread block may refer to a plurality of groups of threads including instructions to perform the task. Threads in the same group of threads may exchange data through shared memory. In one embodiment, a group of threads comprises 32 related threads.

FIG. 4A illustrates a GPC 350 of the PPU 300 of FIG. 3, in accordance with one embodiment. As shown in FIG. 4A, each GPC 350 includes a number of hardware units for processing tasks. In one embodiment, each GPC 350 includes a pipeline manager 410, a pre-raster operations unit (PROP) 415, a raster engine 425, a work distribution crossbar (WDX) 480, a memory management unit (MMU) 490, and one or more Texture Processing Clusters (TPCs) 420. It will be appreciated that the GPC 350 of FIG. 4A may include other hardware units in lieu of or in addition to the units shown in FIG. 4A.

In one embodiment, the operation of the GPC 350 is controlled by the pipeline manager 410. The pipeline manager 410 manages the configuration of the one or more TPCs 420 for processing tasks allocated to the GPC 350. In one embodiment, the pipeline manager 410 may configure at least one of the one or more TPCs 420 to implement at least a portion of a graphics rendering pipeline. For example, a TPC 420 may be configured to execute a vertex shader program on the programmable streaming multiprocessor (SM) 440. The pipeline manager 410 may also be configured to route packets received from the work distribution unit 325 to the appropriate logical units within the GPC 350. For example, some packets may be routed to fixed function hardware units in the PROP 415 and/or raster engine 425 while other packets may be routed to the TPCs 420 for processing by the primitive engine 435 or the SM 440.

The PROP unit 415 is configured to route data generated by the raster engine 425 and the TPCs 420 to a Raster Operations (ROP) unit in the partition unit 380, described in more detail below. The PROP unit 415 may also be configured to perform optimizations for color blending, organize pixel data, perform address translations, and the like.

The raster engine 425 includes a number of fixed function hardware units configured to perform various raster operations. In one embodiment, the raster engine 425 includes a setup engine, a course raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x,y coverage mask for a tile) for the primitive. The output of the coarse raster engine may transmitted to the culling engine where fragments associated with the primitive that fail a z-test are culled, and transmitted to a clipping engine where fragments lying outside a viewing frustum are clipped. Those fragments that survive clipping and culling may be passed to a fine raster engine to generate attributes for the pixel fragments based on the plane equations generated by the setup engine. The output of the raster engine 425 comprises fragments to be processed, for example, by a fragment shader implemented within a TPC 420.

Each TPC 420 included in the GPC 350 includes an M-Pipe Controller (MPC) 430, a primitive engine 435, one or more SMs 440, and one or more texture units 445. The MPC 430 controls the operation of the TPC 420, routing packets received from the pipeline manager 410 to the appropriate units in the TPC 420. For example, packets associated with a vertex may be routed to the primitive engine 435, which is configured to fetch vertex attributes associated with the vertex from the memory 304. In contrast, packets associated with a shader program may be transmitted to the SM 440.

In one embodiment, the texture units 445 are configured to load texture maps (e.g., a 2D array of texels) from the memory 304 and sample the texture maps to produce sampled texture values for use in shader programs executed by the SM 440. The texture units 445 implement texture operations such as filtering operations using mip-maps (i.e., texture maps of varying levels of detail). The texture unit 445 is also used as the Load/Store path for SM 440 to MMU 490. In one embodiment, each TPC 420 includes two (2) texture units 445.

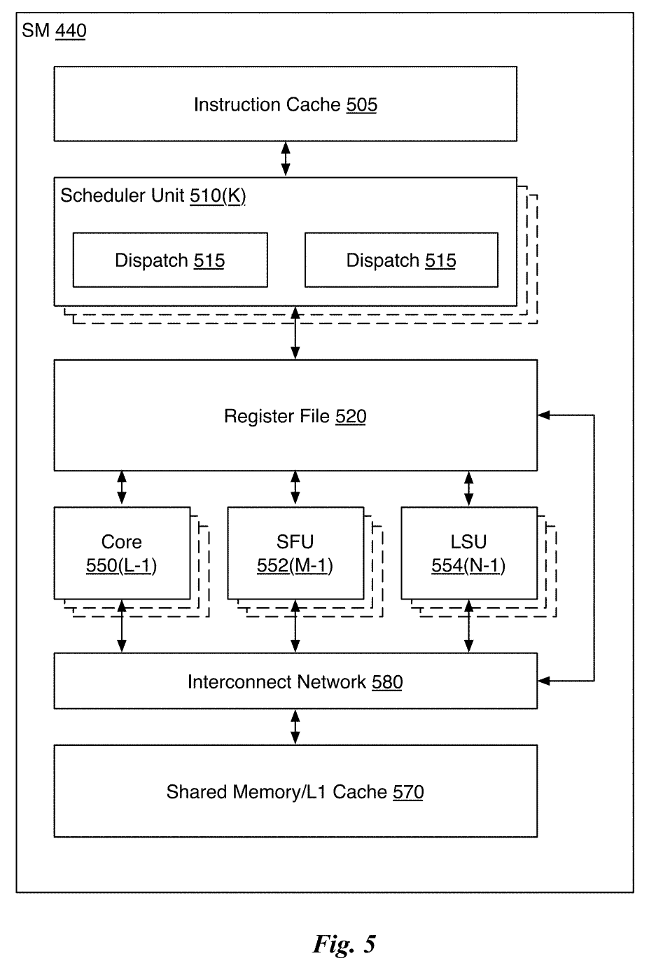

The SM 440 comprises a programmable streaming processor that is configured to process tasks represented by a number of threads. Each SM 440 is multi-threaded and configured to execute a plurality of threads (e.g., 32 threads) from a particular group of threads concurrently. In one embodiment, the SM 440 implements a SIMD (Single-Instruction, Multiple-Data) architecture where each thread in a group of threads (i.e., a warp) is configured to process a different set of data based on the same set of instructions. All threads in the group of threads execute the same instructions. In another embodiment, the SM 440 implements a SIMT (Single-Instruction, Multiple Thread) architecture where each thread in a group of threads is configured to process a different set of data based on the same set of instructions, but where individual threads in the group of threads are allowed to diverge during execution. In other words, when an instruction for the group of threads is dispatched for execution, some threads in the group of threads may be active, thereby executing the instruction, while other threads in the group of threads may be inactive, thereby performing a no-operation (NOP) instead of executing the instruction. The SM 440 may be described in more detail below in conjunction with FIG. 5.

The MMU 490 provides an interface between the GPC 350 and the partition unit 380. The MMU 490 may provide translation of virtual addresses into physical addresses, memory protection, and arbitration of memory requests. In one embodiment, the MMU 490 provides one or more translation lookaside buffers (TLBs) for improving translation of virtual addresses into physical addresses in the memory 304.

FIG. 4B illustrates a memory partition unit 380 of the PPU 300 of FIG. 3, in accordance with one embodiment. As shown in FIG. 4B, the memory partition unit 380 includes a Raster Operations (ROP) unit 450, a level two (L2) cache 460, a memory interface 470, and an L2 crossbar (XBar) 465. The memory interface 470 is coupled to the memory 304. Memory interface 470 may implement 16, 32, 64, 128-bit data buses, or the like, for high-speed data transfer. In one embodiment, the PPU 300 comprises U memory interfaces 470, one memory interface 470 per partition unit 380, where each partition unit 380 is connected to a corresponding memory device 304. For example, PPU 300 may be connected to up to U memory devices 304, such as graphics double-data-rate, version 5, synchronous dynamic random access memory (GDDR5 SDRAM). In one embodiment, the memory interface 470 implements a DRAM interface and U is equal to 8.

In one embodiment, the PPU 300 implements a multi-level memory hierarchy. The memory 304 is located off-chip in SDRAM coupled to the PPU 300. Data from the memory 304 may be fetched and stored in the L2 cache 460, which is located on-chip and is shared between the various GPCs 350. As shown, each partition unit 380 includes a portion of the L2 cache 460 associated with a corresponding memory device 304. Lower level caches may then be implemented in various units within the GPCs 350. For example, each of the SMs 440 may implement a level one (L1) cache. The L1 cache is private memory that is dedicated to a particular SM 440. Data from the L2 cache 460 may be fetched and stored in each of the L1 caches for processing in the functional units of the SMs 440. The L2 cache 460 is coupled to the memory interface 470 and the XBar 370.

The ROP unit 450 includes a ROP Manager 455, a Color ROP (CROP) unit 452, and a Z ROP (ZROP) unit 454. The CROP unit 452 performs raster operations related to pixel color, such as color compression, pixel blending, and the like. The ZROP unit 454 implements depth testing in conjunction with the raster engine 425. The ZROP unit 454 receives a depth for a sample location associated with a pixel fragment from the culling engine of the raster engine 425. The ZROP unit 454 tests the depth against a corresponding depth in a depth buffer for a sample location associated with the fragment. If the fragment passes the depth test for the sample location, then the ZROP unit 454 updates the depth buffer and transmits a result of the depth test to the raster engine 425. The ROP Manager 455 controls the operation of the ROP unit 450. It will be appreciated that the number of partition units 380 may be different than the number of GPCs 350 and, therefore, each ROP unit 450 may be coupled to each of the GPCs 350. Therefore, the ROP Manager 455 tracks packets received from the different GPCs 350 and determines which GPC 350 that a result generated by the ROP unit 450 is routed to. The CROP unit 452 and the ZROP unit 454 are coupled to the L2 cache 460 via an L2 XBar 465.

FIG. 5 illustrates the streaming multi-processor 440 of FIG. 4A, in accordance with one embodiment. As shown in FIG. 5, the SM 440 includes an instruction cache 505, one or more scheduler units 510, a register file 520, one or more processing cores 550, one or more special function units (SFUs) 552, one or more load/store units (LSUs) 554, an interconnect network 580, a shared memory/L1 cache 570.

As described above, the work distribution unit 325 dispatches tasks for execution on the GPCs 350 of the PPU 300. The tasks are allocated to a particular TPC 420 within a GPC 350 and, if the task is associated with a shader program, the task may be allocated to an SM 440. The scheduler unit 510 receives the tasks from the work distribution unit 325 and manages instruction scheduling for one or more groups of threads (i.e., warps) assigned to the SM 440. The scheduler unit 510 schedules threads for execution in groups of parallel threads, where each group is called a warp. In one embodiment, each warp includes 32 threads. The scheduler unit 510 may manage a plurality of different warps, scheduling the warps for execution and then dispatching instructions from the plurality of different warps to the various functional units (i.e., cores 550, SFUs 552, and LSUs 554) during each clock cycle.

In one embodiment, each scheduler unit 510 includes one or more instruction dispatch units 515. Each dispatch unit 515 is configured to transmit instructions to one or more of the functional units. In the embodiment shown in FIG. 5, the scheduler unit 510 includes two dispatch units 515 that enable two different instructions from the same warp to be dispatched during each clock cycle. In alternative embodiments, each scheduler unit 510 may include a single dispatch unit 515 or additional dispatch units 515.

Each SM 440 includes a register file 520 that provides a set of registers for the functional units of the SM 440. In one embodiment, the register file 520 is divided between each of the functional units such that each functional unit is allocated a dedicated portion of the register file 520. In another embodiment, the register file 520 is divided between the different warps being executed by the SM 440. The register file 520 provides temporary storage for operands connected to the data paths of the functional units.

Each SM 440 comprises L processing cores 550. In one embodiment, the SM 440 includes a large number (e.g., 128, etc.) of distinct processing cores 550. Each core 550 may include a fully-pipelined, single-precision processing unit that includes a floating point arithmetic logic unit and an integer arithmetic logic unit. The core 550 may also include a double-precision processing unit including a floating point arithmetic logic unit. In one embodiment, the floating point arithmetic logic units implement the IEEE 754-2008 standard for floating point arithmetic. Each SM 440 also comprises M SFUs 552 that perform special functions (e.g., attribute evaluation, reciprocal square root, and the like), and N LSUs 554 that implement load and store operations between the shared memory/L1 cache 570 and the register file 520. In one embodiment, the SM 440 includes 128 cores 550, 32 SFUs 552, and 32 LSUs 554.

Each SM 440 includes an interconnect network 580 that connects each of the functional units to the register file 520 and the LSU 554 to the register file 520, shared memory/L1 cache 570. In one embodiment, the interconnect network 580 is a crossbar that can be configured to connect any of the functional units to any of the registers in the register file 520 and connect the LSUs 554 to the register file and memory locations in shared memory/L1 cache 570.

The shared memory/L1 cache 570 is an array of on-chip memory that allows for data storage and communication between the SM 440 and the primitive engine 435 and between threads in the SM 440. In one embodiment, the shared memory/L1 cache 570 comprises 64 KB of storage capacity and is in the path from the SM 440 to the partition unit 380. The shared memory/L1 cache 570 can be used to cache reads and writes.

The PPU 300 described above may be configured to perform highly parallel computations much faster than conventional CPUs. Parallel computing has advantages in graphics processing, data compression, biometrics, stream processing algorithms, and the like.

When configured for general purpose parallel computation, a simpler configuration can be used. In this model, as shown in FIG. 3, fixed function graphics processing units are bypassed, creating a much simpler programming model. In this configuration, the work distribution unit 325 assigns and distributes blocks of threads directly to the TPCs 420. The threads in a block execute the same program, using a unique thread ID in the calculation to ensure each thread generates unique results, using the SM 440 to execute the program and perform calculations, shared memory/L1 cache 570 communicate between threads, and the LSU 554 to read and write Global memory through partition shared memory/L1 cache 570 and partition unit 380.

When configured for general purpose parallel computation, the SM 440 can also write commands that scheduler unit 320 can use to launch new work on the TPCs 420. In one embodiment, the PPU 300 comprises a graphics processing unit (GPU). The PPU 300 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 300 can be configured to process the graphics primitives to generate a frame buffer (i.e., pixel data for each of the pixels of the display).

An application writes model data for a scene (i.e., a collection of vertices and attributes) to a memory such as a system memory or memory 304. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the SMs 440 of the PPU 300 including one or more of a vertex shader, hull shader, domain shader, geometry shader, and a pixel shader. For example, one or more of the SMs 440 may be configured to execute a vertex shader program that processes a number of vertices defined by the model data. In one embodiment, the different SMs 440 may be configured to execute different shader programs concurrently. For example, a first subset of SMs 440 may be configured to execute a vertex shader program while a second subset of SMs 440 may be configured to execute a pixel shader program. The first subset of SMs 440 processes vertex data to produce processed vertex data and writes the processed vertex data to the L2 cache 460 and/or the memory 304. After the processed vertex data is rasterized (i.e., transformed from three-dimensional data into two-dimensional data in screen space) to produce fragment data, the second subset of SMs 440 executes a pixel shader to produce processed fragment data, which is then blended with other processed fragment data and written to the frame buffer in memory 304. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The PPU 300 may be included in a desktop computer, a laptop computer, a tablet computer, a smart-phone (e.g., a wireless, hand-held device), personal digital assistant (PDA), a digital camera, a hand-held electronic device, and the like. In one embodiment, the PPU 300 is embodied on a single semiconductor substrate. In another embodiment, the PPU 300 is included in a system-on-a-chip (SoC) along with one or more other logic units such as a reduced instruction set computer (RISC) CPU, a memory management unit (MMU), a digital-to-analog converter (DAC), and the like.

In one embodiment, the PPU 300 may be included on a graphics card that includes one or more memory devices 304 such as GDDR5 SDRAM. The graphics card may be configured to interface with a PCIe slot on a motherboard of a desktop computer that includes, e.g., a northbridge chipset and a southbridge chipset. In yet another embodiment, the PPU 300 may be an integrated graphics processing unit (iGPU) included in the chipset (i.e., Northbridge) of the motherboard.

Various programs may be executed within the PPU 300 in order to implement the various CNN, FC 135, and RNN 235 layers of the video classification systems 115, 145, 200, 215, and 245. For example, the device driver may launch a kernel on the PPU 300 to implement at least one 2D or 3D CNN layer on one SM 440 (or multiple SMs 440). The device driver (or the initial kernel executed by the PPU 300) may also launch other kernels on the PPU 300 to perform other CNN layers, such as the FC 135, RNN 235 and the classifier 105, 106, or 206. In addition, some of the CNN layers may be implemented on fixed unit hardware implemented within the PPU 300. It will be appreciated that results from one kernel may be processed by one or more intervening fixed function hardware units before being processed by a subsequent kernel on an SM 440.

### Exemplary System

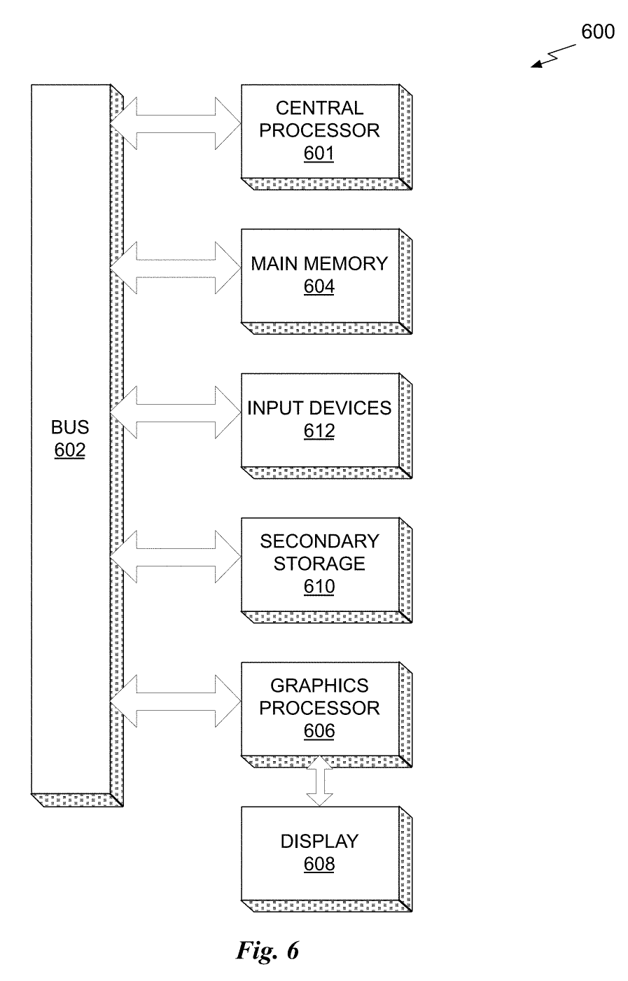

FIG. 6 illustrates an exemplary system 600 in which the various architecture and/or functionality of the various previous embodiments may be implemented. The exemplary system 600 may be used to implement the image-to-image translation systems 150, 200, and/or 250.

As shown, a system 600 is provided including at least one central processor 601 that is connected to a communication bus 602. The communication bus 602 may be implemented using any suitable protocol, such as PCI (Peripheral Component Interconnect), PCI-Express, AGP (Accelerated Graphics Port), HyperTransport, or any other bus or point-to-point communication protocol(s). The system 600 also includes a main memory 604. Control logic (software) and data are stored in the main memory 604 which may take the form of random access memory (RAM).

The system 600 also includes input devices 612, a graphics processor 606, and a display 608, i.e. a conventional CRT (cathode ray tube), LCD (liquid crystal display), LED (light emitting diode), plasma display or the like. User input may be received from the input devices 612, e.g., keyboard, mouse, touchpad, microphone, and the like. In one embodiment, the graphics processor 606 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 600 may also include a secondary storage 610. The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 604 and/or the secondary storage 610. Such computer programs, when executed, enable the system 600 to perform various functions. The memory 604, the storage 610, and/or any other storage are possible examples of computer-readable media. Data streams associated with gestures may be stored in the main memory 604 and/or the secondary storage 610.

In one embodiment, the architecture and/or functionality of the various previous figures may be implemented in the context of the central processor 601, the graphics processor 606, an integrated circuit (not shown) that is capable of at least a portion of the capabilities of both the central processor 601 and the graphics processor 606, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 600 may take the form of a desktop computer, laptop computer, server, workstation, game consoles, head-mounted display, embedded system, and/or any other type of logic. Still yet, the system 600 may take the form of various other devices including, but not limited to a personal digital assistant (PDA) device, a mobile phone device, a television, autonomous vehicle, etc.

Further, while not shown, the system 600 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer-implemented method, comprising:
encoding, by a first neural network, a first image represented in a first domain to convert the first image to a shared latent space, producing a first latent code;
encoding, by a second neural network, a second image represented in a second domain to convert the second image to a shared latent space, producing a second latent code; and
generating, by a third neural network, a first translated image in the second domain based on the first latent code, wherein the first translated image is correlated with the first image and weight values of the third neural network are computed based on the first latent code and the second latent code.

2. The method of claim 1, wherein encoder weight values are shared between a last layer of the first neural network and a last layer of the second neural network.

3. The method of claim 1, further comprising generating, by a fourth neural network, a second translated image in the first domain based on the second latent code, wherein the second translated image is correlated with the second image.

4. The method of claim 3, wherein the weight values include generator weight values that are shared between a first layer of the third neural network and a first layer of the fourth neural network.

5. The method of claim 1, further comprising generating, by the third neural network, a first reconstructed image in the second domain based on the second latent code, wherein the first reconstructed image is correlated with the second image.

6. The method of claim 5, further comprising:
processing, by a first discriminator neural network for the second domain, the second image, the first translated image, and the first reconstructed image to produce comparison data; and
updating parameters of the second neural network and the third neural network to minimize losses for the second neural network and the third neural network based on the comparison data.

7. The method of claim 6, further comprising generating, by a fourth neural network, a second translated image in the first domain based on the first latent code and the second latent code, wherein the second translated image is correlated with the second image.

8. The method of claim 7, further comprising generating, by the fourth neural network, a second reconstructed image in the first domain based on the first latent code and the second latent code, wherein the second reconstructed image is correlated with the first image.

9. The method of claim 8, further comprising:
processing, by a second discriminator neural network for the first domain, the first image, the second translated image, and the second reconstructed image to produce second comparison data; and
updating parameters of the first neural network and the fourth neural network to minimize losses for the first neural network and the fourth neural network based on the second comparison data.

10. The method of claim 5, further comprising processing, by a second discriminator neural network for the first domain, the first image, the second translated image, and the second reconstructed image to produce second comparison data, wherein discriminator weight values are shared between a last layer of the first discriminator neural network and a last layer of the second discriminator neural network.

11. The method of claim 1, wherein the first latent code and the second latent code are equal.

12. The method of claim 1, wherein the first domain is day time and the second domain is night time.

13. The method of claim 1, wherein the first domain is synthetic and the second domain is real.

14. A system, comprising:
a parallel processing unit configured to implement a first neural network, a second neural network, and a third neural network, wherein
the first neural network is configured to encode a first image represented in a first domain to convert the first image to a shared latent space, producing a first latent code,
the second neural network is configured to encode a second image represented in a second domain to convert the second image to a shared latent space, producing a second latent code, and
the third neural network is configured to generate a first translated image in the second domain based on the first latent code, wherein the first translated image is correlated with the first image and weight values of the third neural network are computed based on the first latent code and the second latent code.

15. The system of claim 14, wherein encoder weight values are shared between a last layer of the first neural network and a last layer of the second neural network.

16. The system of claim 14, wherein the parallel processing unit is further configured to implement a fourth neural network that is configured to generate a second translated image in the first domain based on the first latent code and the second latent code, wherein the second translated image is correlated with the second image.

17. The system of claim 16, wherein the weight values include generator weight values that are shared between a first layer of the third neural network and a first layer of the fourth neural network.

18. The system of claim 14, wherein the third neural network is further configured to generate a first reconstructed image in the second domain based on the first latent code and the second latent code, wherein the first reconstructed image is correlated with the second image.

19. The system of claim 18, wherein the parallel processing unit is further configured to implement a first discriminator neural network for the second domain that is configured to:
process the second image, the first translated image, and the first reconstructed image to produce comparison data; and
update parameters of the second neural network and the third neural network to minimize losses for the second neural network and the third neural network based on the comparison data.

20. A non-transitory computer-readable media storing computer instructions for translating images that, when executed by a processor, cause the processor to perform the steps of:
encoding, by a first neural network, a first image represented in a first domain to convert the first image to a shared latent space, producing a first latent code;
encoding, by a second neural network, a second image represented in a second domain to convert the second image to a shared latent space, producing a second latent code; and
generating, by a third neural network, a first translated image in the second domain based on the first latent code, wherein the first translated image is correlated with the first image and weight values of the third neural network are computed based on the first latent code and the second latent code.
